(19) United States
(12) Patent Application Publication
(10) Pub. No.: US 2003/0189642 A1
(43) Pub. Date: Oct. 9, 2003

(54) User-designated image file identification for a digital camera

(76) Inventors: Heather N. Bean, Fort Collins, CO (US); John M. Baron, Longmont, CO (US)

Correspondence Address: HEWLETT-PACKARD COMPANY, Intellectual Property Administration, P.O. Box 272400, Fort Collins, CO, 80527-2400, US

(21) Appl. No.: 10/116,425

(22) Filed: Apr. 4, 2002

(51) Int. Cl. H04N 5/225

(52) U.S. Cl. 348/207.1

(57) ABSTRACT

A digital camera, a user interface for use in a digital camera and a method of file identification employ user-designated file identification of an image recorded by the digital camera. The user-designated file identification provides for a user of the camera to enter file identification data into the camera corresponding to the image. The user-designated file identification receives the data, encodes the data into a filename, and associates the filename with a particular image file. The user-designated file identification comprises voice-based entry and/or button-based entry of the data by the user. For voice-based entry, the user interface comprises a microphone and a voice recognition system. For button-based entry, the user interface comprises a set of preprogrammed alphanumeric strings and associated buttons. Each preprogrammed string corresponds to different preprogrammed data. The user presses a button to select corresponding preprogrammed data to be encoded into the filename.

### TECHNICAL FIELD

The invention relates to electronic devices. In particular, the invention relates to digital cameras and file systems used therein to store image files.

### BACKGROUND OF THE INVENTION

Digital cameras typically use some form of a file system to catalog image files stored in memory of the digital camera. Typically, the file system is fairly rudimentary and identifies files using a simple numerical identifier or filename. Moreover, most digital camera file systems automatically generate and assign such numerical filenames in a sequential manner. Such an automatically generated, sequentially assigned numerical filename is often used in digital cameras due to the lack of a convenient keyboard or keypad for an alternative form of filename entry.

While simple and straightforward, sequentially assigned numerical filenames do not provide a user of the camera with very much useful information regarding the content of the image file. For example, a typical image filename might be ‘IMG004.JPG’ which simply means that the image was a fourth image in a JPEG format recorded in a current sequence of images. No image content information is included in the filename since the camera automatically assigns the filename. Thus, when files are downloaded from the camera for printing and/or additional processing, the user must laboriously examine each image to determine content and decide what to do with the image. In addition, numerical filenames can result in conflicts between image filenames when the image files are downloaded to a personal computer or image file server for subsequent processing and/or storage.

Accordingly, it would be advantageous to have a way of creating an identification for image files in a digital camera that was based on a user input. Such a user-based identification could include, among other things, information regarding image file content. Such user-based identification would solve a long-standing need in digital camera technology.

### SUMMARY OF THE INVENTION

The present invention provides a user of a digital camera the ability to name image files using user-designated file identification (ID). The present invention enables a user of the camera to identify image files by entering data by way of a user interface adapted for user-entry of filename data. The camera then encodes and stores the entered file ID. The file ID is associated with an image file in a file system of the camera as either a complete filename or a portion of a filename of the image file. When viewed in a directory of the camera and/or uploaded at a later time by the user, the filename provides unique identifying information for the associated image file. For example, filenames generated by the user-designated file ID of the present invention may be indicative of an image content of the image file associated therewith. Advantageously, the user-designated file ID of the present invention does not require the use of a specialized or dedicated keyboard or keypad for filename entry. Moreover, the user-designated file ID of the present invention can be implemented as a firmware upgrade to existing digital cameras.

In an aspect of the present invention, a digital camera comprising a user interface with user-designated file ID is provided. The user-designated file identification enables a user to enter file identification data into the user interface. The data is encoded into a filename that is associated with a particular image file created by the digital camera.

In another aspect of the present invention, a user interface for use with a digital camera is provided. The user interface comprises a user-designated file identification, wherein a user of the camera uses the user interface to enter file identification data corresponding to an image recorded with the digital camera. The user-designated file identification comprises encoding the file identification data into a filename, associating the filename with a particular image file, and storing the filename and the associated image file in the digital camera.

In still another aspect of the present invention, a digital camera with user-designated file identification of an image recorded by the digital camera is provided. The camera comprises a user interface, a controller, a memory subsystem having a file system, and a computer program stored in the memory subsystem. The controller executes instructions of the computer program to implement the user-designated file ID. The user interface is under to the control of the controller and the executed computer program. The entered file ID is transformed or encoded by the user interface into a filename that is associated with the image file in the file system of the memory subsystem.

In some embodiments, the user-designated file ID employs a user interface that provides voice-based filename entry. In these embodiments, the user interface comprises a microphone and a voice recognition subsystem. The voice recognition subsystem transforms a file ID voiced by the user and received by the microphone into an alphanumeric string representation suitable for use as a filename of an image file. The produced filename is associated with an image file in the file system of the camera.

In other embodiments, the user-designated file ID employs a user interface having preprogrammed alphanumeric strings and buttons or keys for selecting from among the strings. The strings are preprogrammed by the user to correspond to file IDs or portions thereof. Thus, when an image file is to be named, the user presses one or more buttons to input a specific file ID. The file ID, as entered by the user through the user interface, is then transformed into a filename and associated with an image file in the file system of the camera.

In another aspect of the present invention, a method of user-designated file identification (ID) for a digital camera is provided. In some embodiments, the user-designated file ID is voiced-based. In other embodiments the user-designated file ID employs buttons for file ID entry. The method comprises entering a file ID, encoding the file ID as a filename, and associating the filename with an image file of the digital camera.

For embodiments using the voice-based file ID, entering a file ID comprises receiving and digitizing a voiced file ID. Encoding comprises transforming the digitized voiced file ID into a string representation by applying voice recognition. The string representation preferably represents the voiced file ID. The voiced file ID, encoded as a string, becomes the filename either directly or after additional augmentation.

For embodiments employing buttons to select a particular preprogrammed string, entering a file ID comprises pressing one or more buttons. Encoding comprises creating a file name from preprogrammed data associated with the selected string. In some cases, a file name is created by augmenting the preprogrammed data with additional information, such as a sequentially assigned number and/or other data to produce a unique filename for the image file.

Advantageously, the present invention facilitates the association of descriptive, content related information with an image file in a digital camera. In particular, a descriptive filename that includes information regarding image content can be used to identify the image file in a file system. Such association of descriptive information can result in significant timesavings when files are downloaded since the descriptive information can provide image file content information without the need for opening and viewing the image file. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a block diagram of a digital camera having user-designated file identification (ID) according to the present invention.

FIG. 2 illustrates a block diagram of embodiments of a user interface of the digital camera illustrated in FIG. 1.

FIG. 3 illustrates a block diagram of an imaging subsystem of the digital camera of FIG. 1.

FIG. 4 illustrates a block diagram of another embodiment of a user interface of the digital camera illustrated in FIG. 1.

FIG. 5 illustrates an embodiment of an image display and an exemplary set of three programmable buttons of the user interface illustrated in FIG. 4.

FIG. 6 illustrates a flow chart of a method of user-designated file identification for a digital camera according to the present invention.

FIG. 7A illustrates a flow chart of an embodiment of entering a file ID of the method of FIG. 6.

FIG. 7B illustrates a flow chart of an embodiment of encoding a file ID as a filename of the method of FIG. 6.

### MODES FOR CARRYING OUT THE INVENTION

The present invention provides user-designated file identification (ID) for a digital camera. In particular, the present invention employs one or both of a voice-based file ID entry and a button-based file ID entry to identify or name an image file stored in a file system of the digital camera. A filename created for the image file is designated in part or in full by the user of the digital camera. When designated in part, the digital camera automatically completes the designation by augmenting the user-designated filename with additional data. The user-designated file ID or filename of the present invention facilitates, among other things, an association of image content information with image files of the digital camera. In a preferred embodiment of the present invention, file ID is a user-designated, descriptive filename for the image file in a file system of the digital camera.

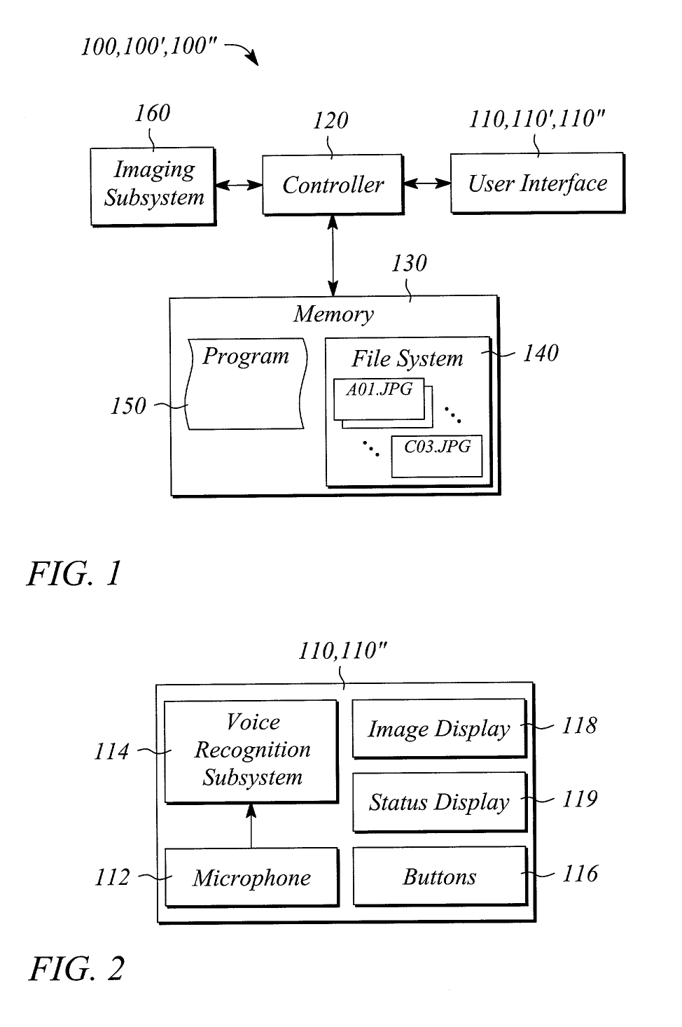

FIG. 1 illustrates a block diagram of an embodiment of a digital camera 100 having user-designated file ID according to the present invention. The digital camera 100 illustrated in FIG. 1 employs voice-based entry of the user-designated file ID. The digital camera 100 comprises a user interface 110, a controller 120, a memory subsystem 130 having a file system 140, a computer program 150 stored in the memory subsystem 130. The user interface 110 of the digital camera 100 provides for and enables the voice-based file ID entry. The digital camera 100 may further comprises an imaging subsystem 160.

FIG. 2 illustrates a block diagram of the user interface 110. The user interface 110 comprises a microphone 112 and a voice recognition subsystem 114 connected to an output of the microphone 112. The microphone 112 receives and transforms a voiced file ID into an audio signal. The audio signal is processed by the voice recognition subsystem 114 that encodes the audio signal. Preferably, the voice recognition subsystem 114 encodes the audio signal in a digital format that is compatible with storage in the memory subsystem 130. The encoded voiced file ID is then transferred to and stored the memory subsystem 130. Within the memory subsystem 130, the file system 140 associates the encoded voiced file ID with an image file.

In addition, the user interface 110 may also comprise one or more of keys or buttons 116, an image display 118, and/or a status display 119. The buttons 116 enable a user to enter commands to control the camera 100 and respond to queries by the camera 100. The image display 118, also referred to as a main display, allows the user to view image files and to access and view the file system 140 using a text or graphics-based file viewer or listing of a directory of the file system 140. The directory contains filenames of images files stored in the file system 140. The status display 119 provides auxiliary status information regarding the camera including, but not limited to, battery fuel gauging, camera mode indication, and percent remaining memory.

The controller 120 is interfaced to the other elements and subsystems 110, 130, 160 of the digital camera. In part through the execution of the computer program 150, the controller 120 controls and coordinates the memory subsystem 130 and the file system 140 thereof, as well as controls the operation of the user interface 110 and other digital camera 100 subsystems, such as the imaging subsystem 160. In particular, instructions of the computer program 150, when executed by the controller 120, provide for association of the encoded voiced file ID with the image file within the image file system 140. Preferably, the file ID is associated with the image file as a filename, or a portion thereof, stored in the directory of the file system 140.

The controller 120 can be any sort of component or group of components capable of providing control and coordination of the subsystems 110, 130, and 160. For example, the controller 120 can be a microprocessor or microcontroller. Alternatively, the controller 120 can be implemented as an application specific integrated circuit (ASIC) or even an assemblage of discrete components. As mentioned above, the controller 120 is interfaced to the various elements and subsystems of the digital camera 100. In particular, the controller 120 is interfaced to the voice recognition subsystem 114 of the user interface 110, the memory subsystem 130, the imaging subsystem 160, and the buttons 116 and displays 118, 119 of the user interface 110. One or more of a digital data bus, a digital line, or analog line may provide such interfacing. In some implementations of the digital camera 100, a portion of the memory subsystem 130 may be combined with the controller 120 and still be within the scope of the present invention.

In a preferred embodiment, the controller 120 comprises a microprocessor and a microcontroller. Typically, the microcontroller provides much lower power consumption than the microprocessor and is used to implement low power-level tasks, such as monitoring button presses and implementing a real-time clock function of the digital camera 100. The microcontroller is primarily responsible for controller 120 functionality that occurs while the digital camera 100 is in ‘stand-by’ or ‘shut-down’ mode. The microcontroller executes a simple computer program that may be a portion of the computer program 150 or may be a separate program. Preferably, the simple computer program is stored as firmware in read-only memory (ROM), the ROM preferably being built into the microcontroller.

On the other hand, the microprocessor implements the balance of the controller-related functionality. In particular, the microprocessor is responsible for all of the computationally intensive tasks of the controller 120, including but not limited to, image formatting, file management of the file system 140, and digital input/output (I/O) formatting for an I/O port or ports of the user interface 110. In the preferred embodiment, the microprocessor executes the computer program 150 of the present invention to implement user-designated file ID according to the present invention.

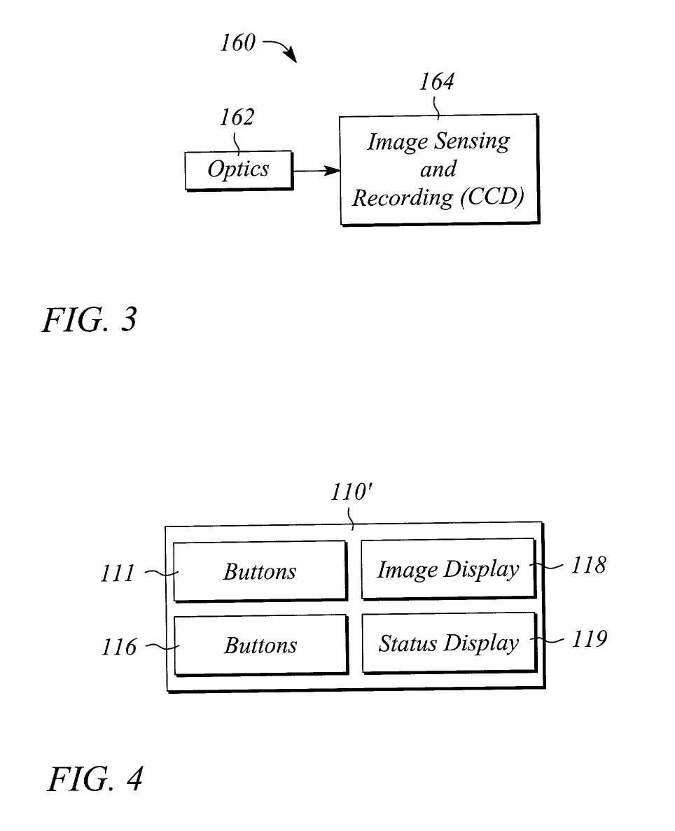

FIG. 3 illustrates a block diagram of the imaging subsystem 160 of the digital camera 100. The imaging subsystem comprises optics 162 and an image sensing and recording 164 portion. The sensing and recording 164 portion preferably comprises a charge coupled device (CCD) array. During operation of the camera 100, the optics 162 project an optical image onto an image plane of the image sensing and recording 164 portion of the imaging system 160. The optics 162 may provide either variable or fixed focusing, as well as optical zoom (i.e., variable optical magnification) functionality. The optical image, once focused, is captured and digitized by the image sensing and recording 164 portion of the imaging subsystem 160. Digitizing produces a digital image. The controller 120 controls the image capturing, the focusing and the zooming functions of the imaging subsystem 160. When the controller 120 initiates the action of capturing an image, the imaging subsystem 160 digitizes and records the image. The digital image is transferred to and stored in the memory subsystem 130 as an image file within the file system 140.

The memory subsystem 130 comprises computer memory for storing digital images, as well as for storing the computer program 150. Moreover, the file system 140 is implemented within the memory subsystem 130. Preferably, the memory subsystem 130 comprises a combination of read only memory (ROM) and random access memory (RAM). The ROM is preferably used to store the computer program 150, while the RAM is used to store digital images from the imaging subsystem 160 as image files. The memory subsystem 130 may also store a directory of the images and/or a directory of stored computer programs therein, including the computer program 150. The file system 140 comprises the directory plus the files listed in the directory.

As mentioned previously hereinabove, in a preferred embodiment of the digital camera 100 of the present invention, the voice recognition subsystem 114 of the user interface 110 encodes the voiced file ID as a string representing a sequence of alphanumeric characters compatible with the file system 140. Preferably, the encoded string is associated with the image file as a filename. Thus, the voiced file ID becomes the filename of the image file. The voiced file ID may contain a description of the image within the image file such that the filename is a descriptive filename. For example, by voicing the words ‘LAKE TAHOE’, an image of Lake Tahoe may be given a filename ‘LAKE TAHOE.JPG’ in the file system 140.

The voice recognition subsystem 114 of the preferred embodiment preferably digitizes the audio signal produced by the microphone 112. Once digitized, the voice recognition subsystem 114 of the preferred embodiment applies a voice recognition algorithm to the digitized audio signal. The voice recognition algorithm locates and identifies portions of the digitized audio signal that correspond to ‘recognizable’ sounds. These recognizable sounds are then encoded as a sequence of alphanumeric characters. Therefore, in some embodiments, the voice recognition subsystem 114 comprises a digitizer portion and a voice recognition portion.

Voice recognition algorithms are well known in the art and come in a variety of forms all of which are within the scope of the present invention. For example, a simple voice recognition algorithm searches for recognizable sounds of letters and numbers within the audio signal. Typically in such a simple voice recognition algorithm, the sounds are identified or recognized through a template matching process. Therefore, the simple voice recognition algorithm preferably employs a voiced file ID that consists of voiced discrete letters and/or numbers or words chosen from a list of ‘keywords’. For example, the voiced file ID may comprise a sequence of discrete voiced letters, such as “L”, “A”, “K”, “E”, “T”, “A”, “H”, “O”, “E”. A more advanced voice recognition algorithm may have the capability to identify and recognize entire words within a voiced file ID, thus eliminating the need to voice the file ID as discrete letters and/or numbers.

The digitizer portion of the voice recognition subsystem 114 usually comprises an analog to digital converter (ADC) while the voice recognition portion may comprise a specialized voice recognition processor. The ADC and voice recognition processor may be implemented as stand alone integrated circuits (ICs) or integrated together as a single IC. In some other implementations of the digital camera 100, the voice recognition subsystem 114 is implemented in hardware as an application specific integrated circuit (ASIC).

Alternatively, the voice recognition subsystem 114 may be integrated with the controller 120 and exist only in a functional sense as opposed to being implemented as specialized hardware. For example, the voice recognition algorithm may be implemented as software or firmware and be part of the computer program 150 while the digitizing portion of the voice recognition subsystem 114 may be realized by using an ADC built in to the controller 120. The controller 120, by executing the computer program 150, processes the audio signal from the microphone directly and produces the alphanumeric string. One skilled in the art can readily devise other permutations and combinations of the above-described realizations and implementations of the voice recognition subsystem 114, all of which are within the scope of the present invention.

In another embodiment, the digital camera 100′ provides a button-based entry of the user-designated file ID. In particular, the camera 100′ employs preprogrammed alphanumeric strings and keys or buttons to access and select a particular string from among the preprogrammed strings. As used hereinbelow, a ‘string’ comprises a sequence of one or more alphanumeric characters that can be used to produce a filename representing a file ID in the file system 140.

Referring again to FIG. 1 illustrating a block diagram of the digital camera 100′, the digital camera 100′ comprises a user interface 110′. As with the digital camera 100 described hereinabove, the digital camera 100′ further comprises a controller 120, and a memory subsystem 130 having a file system 140 and a computer program 150 stored in the memory subsystem 130. The user interface 110′ of the digital camera 100′ provides button-based file ID entry using the preprogrammed strings and the buttons. In addition, the digital camera 100′ may also further comprise an imaging subsystem 160.

FIG. 4 illustrates a block diagram of the user interface 110′. The user interface 110′ comprises a set of alphanumeric strings and a plurality of buttons 111 that are employed in combination to create the file ID. The strings are preferably stored in the memory subsystem 130. In some embodiments, the buttons 111 are each directly associated with a different string of the set. In such an embodiment, pressing a button 111 selects the associated string. In other embodiments, the set of strings is stored in the form of a list and the buttons 111 are employed to select one or more particular strings from the list of strings. In yet other embodiments, the set of strings is stored in the form of a plurality of lists and the buttons 111 are employed to ‘navigate’ between lists, select a particular list from among the plurality of lists, and select a string from the selected list.

In either case, when a button 111 is pressed during user-designated file ID entry, a particular selected string is transferred to the file system 140 for use in creating a filename for an image file. The strings are typically programmed prior to user-designated file entry and therefore, are sometimes referred to herein as ‘preprogrammed’ strings. In addition, the user interface 110′ may also comprise one or more keys or buttons 116, an image display 118, and/or a status display 119. The buttons 116, image display 118, and status display 119 are as described hereinabove with respect to the digital camera 100 having voiced-based file ID entry. The buttons 111 may have other functions when the camera 100′ is not performing or expecting button-based user-designated file ID entry. As such, the buttons 111 may be incorporated as part of the buttons 116.

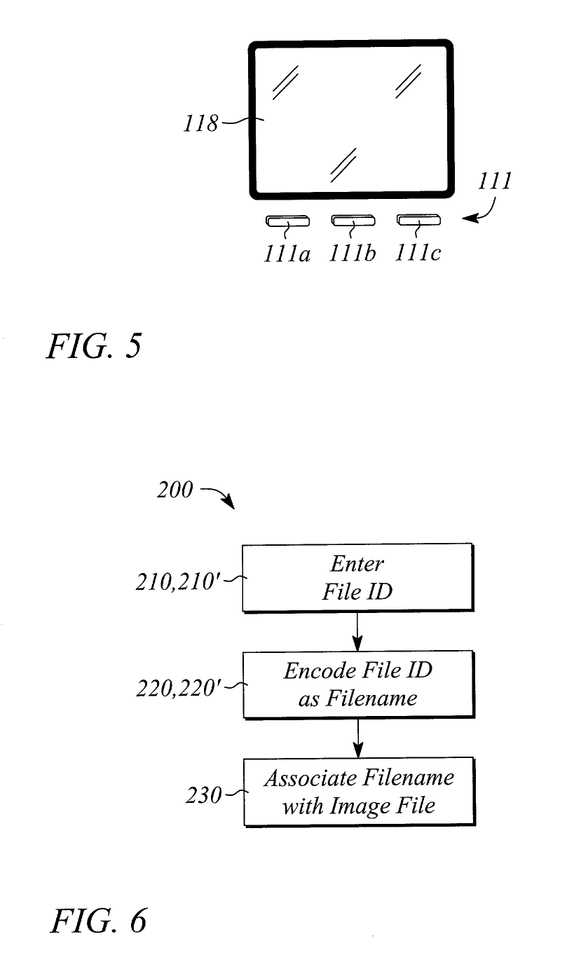

According to some embodiments of camera 100′, an exemplary set of three buttons positioned below the image display 118 may be provided as the buttons 111 of the user interface 110′, as illustrated in FIG. 5. A first button 111a of the set is associated with a first string, a second button 111b of the set is associated with a second string, while a third button 111c of the set is associated with a third string. The exemplary set of three buttons 111, as described herein, is provided for convenience of discussion and is not intended to limit the scope of the present invention

For example, consider a user of the camera 100′ that is planning to take a vacation. The user may decide to use ‘Plane’ as the first string, ‘Train’ as the second string, and ‘Automobile’ as the third string, for example. Therefore, the user may preprogram the first string with ‘Plane’, the second string with ‘Train’, and the third string with ‘Automobile’. How the strings may be programmed in accordance with the present invention is described below.

During the vacation, the user may enter a user-designated file ID for an image recorded by the digital camera 100′ by pressing one of the buttons 111. Which button 111 is pressed determines which of the respective associated strings is transferred to and used in the file system 140 for producing the file ID. Thus for example, image files recorded while traveling in a train can be identified using the ‘Train’ string, while images recorded while traveling in a plane can be identified with the ‘Plane’ string. In other words, pressing a first button 111a after recording an image causes the string ‘Plane’ to be transferred to and associated with an image file of the image in the file system 140. Likewise, pressing a second button 111b causes the string ‘Train’ to be associated with an image file of the image in the file system 140, and so on. Therefore, when traveling on a train, the user merely presses the second button 111b after each image is recorded to identify the images as having been taken on the train.

Appending a sequentially assigned number to the string can uniquely identify multiple instances of image files identified with any one of the preprogrammed strings. Thus, a first image identified with the string ‘Plane’ may have a number “001” appended thereto to produce a file name “Plane001.jpg”, for example. A second image identified with the string “Plane” is the given a filename “Plane002.jpg” and so on. One skilled in the art is familiar with using appended numbers and/or strings to distinguish between multiple instances of files having the same filename.

In another example of the digital camera 100′, the first string may be preprogrammed to be ‘A’, the second string may be preprogrammed to be ‘B’, and the third string may be preprogrammed to be ‘C’. The user can then enter user-designated file IDs to categorize image files as they are taken using the buttons 111. In this example, image files are categorized as belonging to one of a class ‘A’, ‘B’, or ‘C’ of images. The buttons 111, by virtue of their association with the three preprogrammed strings ‘A’, ‘B’, and ‘C’, are used to enter an appropriate class designation for each image file created. For example, at a wedding, class ‘A’ might correspond to images of general crowd scenes, class ‘B’ may refer to pictures of the bride, and ‘C’ may be images taken during the ceremony. Again, numbers appended to the strings can be used to distinguish multiple images in each of the possible classes. Whether using descriptive strings, such as ‘Plane’ and ‘Train’, or cryptic class designation strings, such as ‘A’ and ‘B’, images can be readily recognized by the user when viewing a directory of the file system 140 according to the user-designated file ID of the present invention.

According to other embodiments, a list of preprogrammed strings is stored in the memory subsystem 130 of the digital camera 100′. To input a user-designated file ID, the user uses the buttons 111 to select one or more strings from the list. When using such a list, the list is typically ‘viewed’ by the user. The list may be viewed on the image display 118, for example.

An exemplary user interface 110′ having three buttons 111 may be employed as illustrated in FIG. 4. A first button 111a may be used to scroll down in the list, a second button 111b may be used to scroll up in the list, and a third button 111c may be used to select a particular string from the list, for example. By scrolling and selecting from available strings, a user-designated file ID in the form of a filename can be assembled for a given image file.

Programming of the strings and/or creating the list can be accomplished by any one of several means. For example, the strings can be programmed by placing the digital camera 100′ in a special ‘programming mode’ that employs the buttons 116 of the user interface 110′ as alphanumeric entry keys. Arrow keys of the buttons 116 may be used to scroll through and select letters and/or numbers to assemble an alphanumeric string, for example. Likewise, the list can be created using a similar technique. In another example, an auxiliary keypad or keyboard (not illustrated) may be attached to the digital camera 100′ using an input/out port. The keyboard may then be used to program the strings and/or create the list. In yet another example, programming of the strings and/or the list may be accomplished offline using, for example, a personal computer (PC). In this case, the programming comprises creating the strings in the PC and uploading the strings using an I/O port of the digital camera 100′. One skilled in the art is familiar with uploading data, such as strings into a digital camera 100′.

In yet another embodiment of the digital camera 100″, the user-designated file ID employs a combination of both voice-based file ID entry and button-based file ID entry to name files. This embodiment of the digital camera 100″ is essentially a combination of the digital camera 100 having voiced-based file ID entry and the digital camera 100′ providing button-based file ID entry. In particular, the user interface 110″ in this embodiment combines the aspects of both the voiced-based entry user interface 110 and the preprogrammed strings and buttons user interface 110′ described hereinabove. With this embodiment of the digital camera 100″, the user is able to choose which of voice-based or button-based entry is most applicable in a given situation.

To better understand the present invention, consider the following example of the digital camera 100 and its operational use with respect to user-designated file ID according to the present invention. The description hereinbelow of the digital camera 100 is exemplary only and is not intended to limit the scope of the present invention. Moreover, for the purposes of the discussion of this example and in no way by limitation, the camera 100 is assumed to employ a simple voice recognition algorithm implemented as part of the computer program 150 that recognizes discrete letters and numbers only. The block diagrams illustrated in FIGS. 1 and 2 represent the digital camera 100 of this example.

A user of the camera 100 captures an image by pressing a button of the buttons 116 of the user interface 110. When the button 116 is pressed, the imaging subsystem 160 records an image as a digital image file. The controller 120, executing the computer program 150, prompts the user to enter a file ID for the image just recorded. For example, the controller 120 may cause a transducer that is part of the user interface 110 to emit a noise, such as a ‘beep’. Upon receiving the prompt (e.g., hearing the beep) the user voices a file ID by speaking into the microphone 112.

Further for this example using the camera 100, the user voices the file ID by verbally spelling out the desired file ID. For example, the user might voice the letters “R”, “K”, “Y”, “M”, “T”, “N”, and “S” to create a file ID that indicates that the image is of the Rocky Mountains. The microphone 112 transforms each of these voiced letters into an audio signal. The voice recognition subsystem 114 recognizes and encodes each of the voiced letters as characters of a string by first digitizing the audio signal and applying the simple voice recognition algorithm to the digitized audio signal. When the user is finished voicing the file ID, the voice entry is said to be completed. When the voice entry is completed, the string is terminated and transferred to the controller 120. For example, the string for the above example sequence of voiced letters is ‘RKYMTNS’.

According to the present invention, the camera 100 may recognize that the user is finished voicing the file ID in any one of several ways. For example, in a way to recognize that the user is finished, the camera 100 is programmed or designed to assume that the user is finished when no new voiced letters are recognized after a period of time. If no new letters are recognized in the audio signal from the microphone 112 after a period of five seconds, for example, the camera 100 may assume that the user is finished. In another way, the user may indicate that the voiced entry is finished by pressing a designated button of the buttons 116 on the user interface 110, for example. In still another way, recognition of a predefined maximum number of characters may be used by the camera to determine that voiced entry is finished. For example, a maximum length of a filename may be 128 characters, so that once 128 characters are recognized, the camera 100 automatically terminates the string. These and other ways of recognizing that the user is finished that are apparent to one skilled in the art are within the scope of the present invention. However, for the purposes of discussion herein with regard to the example, it is assumed that user presses a particular button of the buttons 116 on the user interface 110 of the camera 100 to indicate that voice entry is completed.

Once the voiced entry is completed and the voiced letters of the file ID are encoded as the string of characters, the controller 120, via the executed computer program 150, appends a file type such as ‘JPG’ to the string. The file type may or may not indicate a file format of the image file. Using the executed computer program 150, the controller 120 then associates the appended string with the image file. Preferably, the appended string is entered into a directory of the file system 140 as a filename for an image file created for the image. The file system 140 then contains a reference to the image file having the filename wherein the filename is the appended string. For the above-described example, the file system 140 would contain an entry in the directory having the filename ‘RKYMTNS.JPG’ that pointed to (or is associated with) the image file. In other words, the filename of the image file is ‘RKYMTNS.JPG’. The user can use the image display 118 of the user interface 110 to view the directory. The descriptive filename ‘RKYMTNS.JPG’ will indicate to the user the content of the image file.

While the digital camera 100 of this example prompted the user to name the image file immediately following the creation of the image, in other embodiments, the voiced file ID may be entered for a particular image at any time following the creation of the image file. For example, the user may create several images that are stored in the memory subsystem 130 as image files having automatically assigned filenames. The user may then select one or more of these files and enter a voiced file ID to be associated with each selected file. For example, an image having the automatically assigned filename ‘IMG003.JPG’ may be selected. The user can then voice a file ID, such as “R”, “K”, “Y”, “M”, “T”, “N”, “S”. Once the voiced file ID has been encoded as a character string, the controller 120, through the executed computer program 150, then replaces the filename IMG003.JPG in the directory with the filename ‘RKYMTNS.JPG’ created from the voiced file ID. Thus, the image file is given a descriptive filename using the voice-based file ID of the present invention.

In another aspect of the present invention, a method 200 of user-designated file identification (ID) in a digital camera is provided. FIG. 6 illustrates a flow chart of the method 200 according to the present invention. The method 200 of user-designated file ID comprises entering 210 a file ID. In some embodiments, entering 210 a file ID is accomplished by a voice-based file ID entry. Voice-based file ID entry 210 uses voice recognition to recognize a sequence of discrete voiced characters of a descriptive filename or a complete voiced file ID in the form of a filename. In other embodiments, entering 210′ a file ID is accomplished using buttons on the digital camera. Button-based file ID entry 210′ utilizes preprogrammed userdesignated file identifiers associated with the buttons to produce filenames having a user-designated meaning. The preprogrammed identifiers preferably comprise alphanumeric strings.

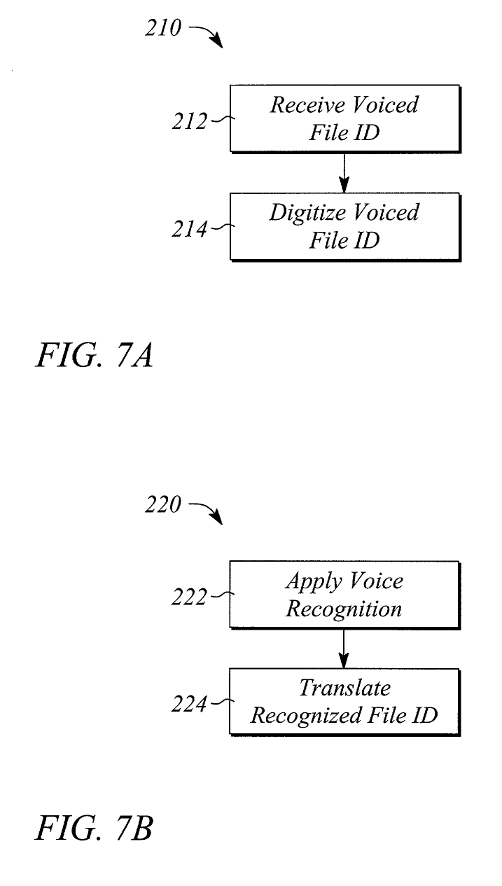

FIG. 7A illustrates a flow chart of the voice-based file ID entry 210 embodiment of the method 200. Voice-based file ID entry 210 comprises receiving 212 and digitizing 214 a voiced file ID. In a preferred embodiment, the voiced file ID is received 212 by a microphone of the digital camera. The microphone transforms the voiced file ID into an electronic audio signal. The audio signal is then digitized 214 by an analog to digital converter (ADC) of the digital camera to produce a digital signal. In some embodiments, the microphone may directly digitize the voiced file ID and thus, produces a digitized audio signal without the need for separate digitization 214.

Button-based file ID entry 210′ comprises pressing one or more buttons on the digital camera. The buttons are associated with or used to select preprogrammed strings serving as user-designated file identifiers. Pressing one or more of the buttons selects one or more of the strings. Preferably, the strings are in a format consistent with a filenames of a file system used to store image files in the digital camera, where each string comprises a sequence of one or more alphanumeric characters. More preferably, each of the strings has a unique meaning that may be recognized by the user at a later time. The strings are preprogrammed, as described above for the digital camera 100′ and the user interface 110′.

The method 200 further comprises encoding 220 the entered 210, 210′ file ID as a filename. FIG. 7B illustrates a flow chart of encoding 220 according to a voice-based entry embodiment of the method 200. For voiced-based file ID entry 210, encoding 220 comprises applying 222 voice recognition to the digitized 214 voiced file ID. Encoding 220 further comprises translating 224 the recognized voiced file ID into a string containing alphanumeric characters. The string is preferably in a format consistent with a filenames of a file system used to store image files in the digital camera. In some embodiments, the user may be allowed to edit the translated string prior to accept it. In other embodiments, the user is prompted by the camera to either accept or reject the translated string. If the string is rejected, the user may be allowed to reenter the voiced file ID. Once accepted, the string either becomes the filename or is further augmented by appending additional data before becoming the filename.

According to those embodiments that employ button-based file ID entry 210′, encoding 220′ comprises using the user-designated file ID associated with the pressed 212′ button to create the filename. As with voiced file ID entry, the filename created by encoding 220′ may be further augmented prior to its use as an image filename. Moreover, an opportunity to edit, accept or reject the encoded filename may be provided. Examples of further augmentation include, but are not limited to, adding a sequentially assigned number or letter to distinguish the filename from other similar filenames of images already stored in the camera and/or adding a date or time stamp.

The method 200 further comprises associating 230 the filename with an image file. The filename is the encoded file ID 220, 220′. In the preferred embodiment, the association is accomplished by using the string as a filename for the image file in a directory of a file system of the digital camera. The association 230 may occur when an image is first recorded or may be performed at a time subsequent to image recording. In the latter case, a temporary filename, such as a numerical filename, may be used by the file system of the camera to designate the image.

Thus, there have been described a novel digital camera and a user interface for a digital camera having user-designated file ID and a method of user-designated file ID for a digital camera. It should be understood that the above-described embodiments are merely illustrative of the some of the many specific embodiments that represent the principles of the present invention. Clearly, those skilled in the art can readily devise numerous other arrangements without departing from the scope of the present invention as defined by the following claims.

What is claimed is:

1. A digital camera comprising:
a user interface that comprises a user-designated file identification, such that file identification data entered into the user interface by a user is encoded into a filename that is associated with a particular image file, the image file being created by the digital camera.

2. The digital camera of claim 1, wherein the user interface comprises a microphone and a voice recognition system, such that entry of the file identification data by the user is voice-based entry.

3. The digital camera of claim 1, wherein the user interface comprises a set of buttons and a set of alphanumeric strings preprogrammed by the user, such that entry of the file identification data by the user is button-based entry.

4. The digital camera of claim 3, wherein each button of the set is directly associated with a different one of the preprogrammed strings, each string comprising a different sequence of one or more alphanumeric characters.

5. The digital camera of claim 3, wherein the set of alphanumeric strings are in the form of a list and the set of buttons is used to select a string from the list.

6. A user interface for use with a digital camera comprising:
a user-designated file identification of an image recorded with the digital camera, the user-designated file identification comprising encoding user-designated file identification data into a filename, associating the filename with a particular image file, and storing the filename and the associated image file in the digital camera, wherein the file identification data is entered into the user interface by a user of the digital camera.

7. The user interface of claim 6, wherein the file identification data comprises descriptive image content of the associated image file.

8. The user interface of claim 6, further comprising a microphone and a voice recognition system, the voice recognition system being connected to receive a signal from the microphone, such that when the user vocally enters the file identification data into the microphone, the microphone digitizes the data into the signal, and the voice recognition system transforms the signal into a sequence of alphanumeric characters representing the filename.

9. The user interface of claim 8, wherein the voice recognition system recognizes one of a voiced discrete alphanumeric character and a voiced discrete word.

10. The user interface of claim 8, further comprising a plurality of buttons and a plurality of alphanumeric strings, the strings being preprogrammed by the user, such that the user alternatively or additionally enters all or a portion of the file identification data into the user interface by pressing a button of the plurality, the pressed button providing an associated alphanumeric string as the filename to correspond to the particular image file.

11. The user interface of claim 10, wherein each string comprises a sequence of one or more alphanumeric characters that represent image content associated with the particular image file.

12. The user interface of claim 8, further comprising a plurality of buttons and preprogrammed data that are preprogrammed by the user, the preprogrammed data being stored as a list that is accessible by the plurality of buttons, the list comprising a plurality of different alphanumeric character strings, wherein the buttons of the plurality are used to scroll through the list and select one or more of the strings from the list, the selected one or more strings being encoded into the filename.

13. The user interface of claim 6, further comprising a plurality buttons and a plurality of strings, the strings being preprogrammed by the user, each preprogrammed string of the plurality comprising different preprogrammed data accessible by a different button of the plurality, such that when the user presses a button of the plurality to enter the file identification data into the user interface, the preprogrammed data corresponding to the pressed button is encoded into the filename that is associated with the particular image file.

14. The user interface of claim 13, wherein the preprogrammed data associated with each button is encoded by transforming the preprogrammed data into a sequence of alphanumeric characters that represent image content associated with the particular image file.

15. The user interface of claim 13, wherein the preprogrammed data associated with each button comprises a sequence of alphanumeric characters, each sequence representing one or more of a classification for, descriptive information about and an ordering of a selection of image files.

16. The user interface of claim 13, further comprising a programming mode to preprogram the plurality of strings, the programming mode using one or more of the buttons, an auxiliary keyboard and a personal computer for alphanumeric data entry.

17. A digital camera with user-designated file identification of an image recorded by the digital camera comprising:
a user interface comprising a data input portion and a display;
a memory subsystem comprising a computer program and a file system, the computer program implementing user-designated file identification;
an imaging subsystem that creates images that are stored in the file system; and
a controller that controls the user interface, the memory subsystem and the imaging subsystem, the controller executing the computer program, the computer program comprising instructions that, when executed by the controller, receive file identification data from a user of the camera at the data input portion of the user interface, encode the received identification data into a filename, associate the filename with a particular image file, and store the filename with the associated image file in the file system of the memory subsystem.

18. The digital camera of claim 17, wherein the computer program further comprises instructions that prompt the user to enter the file identification data for the particular image file.

19. The digital camera of claim 18, wherein the instructions that prompt the user to enter the file identification data comprise one or more of prompting the user prior to recording the particular image with the imaging subsystem, after recording the particular image, prior to recording a group of images with the imaging subsystem, and after recording the group of images.

20. The digital camera of claim 17, wherein the file identification data comprises descriptive image content of an image in the particular image file.

21. The digital camera of claim 17, wherein the data input portion of the user interface comprises a microphone and a voice recognition system, such that entry of the file identification data by the user is voice-based entry.

22. The digital camera of claim 21, wherein the instructions that encode the file identification data that is voiced by the user into the microphone comprises converting the voiced data into an audio signal with the microphone, and processing the audio signal by the voice recognition system, such that the audio signal is transformed into a sequence of alphanumeric characters representing the filename.

23. The digital camera of claim 17, wherein the data input portion of the user interface comprises a set of buttons and a set of data strings, the strings being preprogrammed by the user, each button of the set accessing a different preprogrammed string, such that entry of the file identification data by the user is button-based entry.

24. The digital camera of claim 17, wherein the data input portion of the user interface comprises a list of data strings preprogrammed by the user and a set of buttons, the strings comprising a sequence of alphanumeric characters, the buttons being used to scroll through the list and select one or more of the strings from the list, the selected strings becoming the file identification data entered by the user.

25. The digital camera of claim 23, wherein the instructions that encode the received file identification data entered by pressing a button of the set comprises transforming the preprogrammed data string corresponding to the pressed button into the filename.

26. The digital camera of claim 25, wherein each preprogrammed data string comprises a different sequence of one or more alphanumeric characters that represent image content associated with the particular image file.

27. The digital camera of claim 21, wherein the data input portion of the user interface comprises a plurality of buttons and a plurality of data strings, the strings being preprogrammed by the user, each preprogrammed string of the plurality comprises different preprogrammed data that is accessed by a different button, such that entry of the file identification data by the user is alternatively or additionally button-based entry.

28. The digital camera of claim 27, wherein the instructions that encode the file identification data that is entered by button-based entry comprises transforming the preprogrammed data corresponding to a pressed button into a sequence of alphanumeric characters representing the filename associated with the particular image file.

29. The digital camera of claim 27, wherein the preprogrammed data associated with each string comprises a sequence of one or more alphanumeric characters that represents image content associated with the particular image file.

30. The digital camera of claim 27, wherein the preprogrammed data associated with each string comprises a sequence of one or more alphanumeric characters, each sequence representing one or more of a classification for, descriptive information about and an ordering of a selection of image files.

31. The digital camera of claim 23, wherein the user interface further comprises a programming mode to preprogram the set of strings using one or more of the buttons, an auxiliary keyboard and a personal computer for alphanumeric data entry.

32. A digital camera with voice-based file identification comprising:
a user interface comprising a microphone and a voice recognition system;
a memory subsystem comprising a computer program and a file system;
an imaging subsystem that creates image files that are stored in the file system; and
a controller that controls the user interface, the memory subsystem and the imaging subsystem, the controller executing the computer program, the computer program comprising instructions that, when executed by the controller, convert file identification data voiced by a user into the microphone into an audio signal, transform the audio signal into a sequence of alphanumeric characters representing a filename with the voice recognition system, associate the filename with a particular image file, and store the filename with the associated image file in the file system of the memory subsystem.

33. The digital camera of claim 32, wherein the voice recognition system comprises a digitizer portion that transforms the audio signal into a digital format and a voice recognition portion that is compatible with storage in the memory subsystem.

34. The digital camera of claim 33, wherein the digitizer portion comprises an analog to digital converter, and wherein the voice recognition portion comprises a voice recognition processor.

35. The digital camera of claim 33, wherein the voice recognition portion of the voice recognition system is integrated with the controller.

36. A method of user-designated file identification of an image recorded with a digital camera comprising:
entering a file identification into a user interface of the digital camera;
encoding the entered file identification as a filename; and
associating the filename with an image file of the digital camera.

37. The method of claim 36, further comprising editing the filename.

38. The method of claim 36, further comprising:
prompting a user to accept or reject the filename; and
editing the filename when the user rejects the filename.

39. The method of claim 36, wherein entering a file identification comprises:
prompting a user to enter the file identification.

40. The method of claim 39, wherein the user is prompted to enter the file identification either before or after the user causes the digital camera to record the image as the image file.

41. The method of claim 36, wherein entering a file identification comprises:
receiving a voice-based file identification from a user of the digital camera; and
digitizing the voice-based file identification into a signal.

42. The method of claim 41, wherein encoding the entered file identification as a filename comprises:
transforming the signal into a sequence of alphanumeric characters using voice recognition; and
using the sequence as the filename.

43. The method of claim 42, wherein using the sequence as the filename comprises either using the sequence directly as the filename or augmenting the sequence and using the augmented sequence as the filename.

44. The method of claim 36, wherein entering a file identification comprises:
pressing a button of a set of buttons, each button of the set being associated with a different programmed string, each of the strings comprising different preprogrammed data, the pressed button providing the preprogrammed data corresponding to the entered file identification.

45. The method of claim 44, wherein encoding the entered file identification comprises transforming the preprogrammed data associated with the pressed button into the filename.

46. The method of claim 45, wherein the data of each preprogrammed string comprises a sequence of alphanumeric characters, the sequence providing a portion of the filename.

47. The method of claim 45, wherein the data of each preprogrammed string comprises a sequence of one or more alphanumeric characters, the sequence having a unique meaning that is recognized by the user.

48. The method of claim 45, wherein encoding the entered file identification further comprises augmenting the preprogrammed data with additional information so that the filename is unique for the image file.

49. A method of voice-based file identification of an image recorded with a digital camera comprising:
vocally entering a file identification into a user interface of the digital camera;
transforming the voiced file identification into a sequence of one or more alphanumeric characters using voice recognition, the sequence being the filename; and
associating the filename with an image file created with the digital camera, the associated filename and image file being stored by the digital camera.

50. The method of voice-based file identification of claim 49, further comprising:
augmenting the sequence with additional filename information.

51. The method of voice-based file identification of claim 49, wherein the user vocally enters the identification by speaking the file identification into a microphone of the user interface, the microphone digitizing the vocalized file identification into an audio signal, the audio signal being the voiced file identification that is transformed into the filename.

52. The method of voice-based file identification of claim 49, wherein the voice recognition transforms the voiced file identification into one or more of a discrete letter, a discrete number and a discrete word.
